(19) United States
(12) Patent Application Publication
(10) Pub. No.: US 2013/0339054 A1
(43) Pub. Date: Dec. 19, 2013

(54) SYSTEM AND METHOD FOR PROVIDING MEDICAL INFORMATION TO LABOR AND DELIVERY STAFF

(71) Applicant: Greenway Medical Technologies, Inc., Carrollton, GA (US)

(72) Inventors: W. Thomas Green, III, Carrollton, GA (US); James T. Ingram, Carrollton, GA (US); Gregory H. Schulenburg, Carrollton, GA (US); Jason Colquitt, Carrollton, GA (US); Johnathan Samples, Carrollton, GA (US); Steve Felt, Hamilton, GA (US)

(21) Appl. No.: 13/905,733

(22) Filed: May 30, 2013

Related U.S. Application Data
(60) Provisional application No. 61/653,222, filed on May 30, 2012.

(51) Int. Cl. G06F 19/00

(52) U.S. Cl. CPC G06F 19/322
USPC 705/3

(57) ABSTRACT

A remote labor and delivery service project provides details captured from one or more encounters. Essentially, it is the assembly of records aggregated over the course of the duration of the patient's visits but viewable remotely by a secure portal. The Labor and Delivery user will be able to select a patient from a group of pregnant women and select a specific pregnant patient. In some embodiments, the provider will be able to view the patient's prenatal flow sheets, prenatal lab, and antepartum summary.

### REFERENCE TO RELATED APPLICATION

The present application claims the benefit of U.S. Provisional Patent Application No. 61/653,222, filed May 30, 2012, whose disclosure is hereby incorporated by reference in its entirety into the present disclosure.

### FIELD OF THE INVENTION

The present invention is directed to providing information from medical records and more particularly to providing information from medical records collected during a patient's pregnancy to labor and delivery staff.

### DESCRIPTION OF RELATED ART

Traditionally, healthcare providers have kept all of their patients' information in paper filing systems. That patient information includes, but is not limited to, patients' demographic information (e.g., age, weight, gender, race, income, and geographic location) and health-related information (e.g., clinician documentation of observations, thoughts and actions, treatments administered, patient history, medication and allergy lists, vaccine administration lists, laboratory reports, X-rays, charts, progress notes, consultation reports, procedure notes, hospital reports, correspondence, and test results). The healthcare providers that keep that patient information include, but are not limited to, physicians—Doctor of Medicine (MD) or Doctor of Osteopathic Medicine (DO), dentists, chiropractors, podiatrists, therapists, psychologists, physician assistants, nurses, medical assistants, and technicians.

The manual, paper-based practice of keeping a patient's information, however, is a very inefficient, labor-intensive process requiring many checks and balances to ensure accurate processing of the information and requiring a significant amount of the healthcare provider's time that could otherwise be spent with the patient. Accordingly, electronic medical records (EMRs), Electronic Health Records (EHRs), and Personal Health Records (PHRs) have been developed to provide many of the functionalities and features of paper filing systems in an electronic, paperless format. Systems using EMRs, EHRs, and PHRs have been developed to streamline clinical, financial, and administrative information; to streamline workflow processes; and to improve coding and billing accuracy.

An EMR is an electronic record of patient information that can be created, gathered, managed, and consulted by the authorized clinicians and staff at the specific healthcare provider that creates the record. An EHR is an electronic record of patient information that conforms to nationally recognized interoperability standards and that can be created, managed, and consulted by authorized clinicians and staff at the healthcare provider that creates the record as well as those at other healthcare provider sites. And, a PHR is an electronic record of patient information that conforms to nationally recognized interoperability standards and that can be drawn from multiple sources while being managed, shared, and controlled by the patient to whom it belongs. Accordingly, EMRs are aimed primarily at the efficient management of multiple records in a single healthcare provider's practice, while EHRs and PHRs are aimed primarily at integrating multiple data sources into each electronic record.

The nationally recognized interoperability standards for EHRs are currently endorsed by the Healthcare Information Technology Standards Panel (HTISP) and certified by the Certification Commission for Healthcare Information Technology (CCHIT). Those standards require EHRs to have the ability to communicate and exchange data accurately, effectively, securely, and consistently with different information technology systems, software applications, and networks in various settings such that the clinical or operational purpose and meaning of the data are preserved and unaltered as that data is exchanged. Thus, while an EMR is generally characterized as an electronic version of a physician's paper record, an EHR is characterized as a more comprehensive record containing additional data integrated to and from other sources. EHRs are further characterized as being either “basic” or “fully functional.” A basic EHR includes patient demographics, problem lists, clinical notes, orders for prescription, and viewing laboratory and imaging results. A fully functional EHR includes patient demographics, problem lists, clinical notes, medical history and follow-up, orders for prescriptions, orders for tests, prescription orders sent electronically, laboratory and imaging results, warnings of drug interactions or contraindications, out-of-range test levels, and reminders for guideline-based interventions.

Most of the commercially available EMR and EHR systems, however, have not been well received by healthcare providers. In fact, according to a 2008 survey conducted by the National Center for Health Services (NCHS), a division of the Centers for Disease Control and Prevention (CDC), while about 40% of U.S. office-based physicians reported using EMR systems, only 17% reported using basic EHR systems, and only 4% reported using fully functional EHR systems. Part of the problem with traditional EHR systems is that many of the vendors of those systems have resisted making their software capable of exporting and importing patient information using uniform electronic messaging, document, and form management standards (e.g., the Health Level Seven (HL7) messaging standard, the Continuity of Care Document (CCD) document standard, and the Retrieve Form for Data Capture (RFD) form management standard).

At their core, EMR and EHR systems include large-capacity databases that contain patient information stored in structured, relational tables of searchable data. But, when that data is not captured and stored using uniform, standardized medical vocabularies and it is not transmitted using uniform messaging, document, and form management standards, it is of little use outside of the system in which the data is stored unless custom interfaces are designed to connect that system to other systems so that data can be shared therebetween. The process of developing different interfaces between the disparate formats used by different vendors is expensive and difficult. Moreover, the interfaces are also costly and labor-intensive to maintain.

The problem of interfacing different EHR systems is exacerbated by the fact that, in the present health care system, most patient visits are to small, self-contained practices that often treasure their autonomy and are unwilling and/or unable to acquire EHR systems unless each of those systems is individually tailored to the narrow objectives of each specific self-contained practice. Accordingly, most EHR vendors have been forced to provide healthcare providers with individually customized systems that employ stand-alone features and functions on the basis of what a specific practice group wants and needs. Accordingly, similar practice groups in adjacent counties may have very different system features and functions based on their different priorities. Thus, the various existing systems are not well suited for interaction and data exchange with each other, or for maintaining information that would be useful to the other systems, and the data collected by the different practice groups using EHR systems is therefore severely fragmented.

In addition, the enactment of the privacy and security regulations of the Health Insurance Portability and Accountability Act (HIPAA) has caused major changes in the way physicians and medical centers operate. Implementation of those regulations increased the overall amount of paperwork and the overall costs required for healthcare providers to operate. And, the complex legal implications associated with those regulations have caused concerns with compliance among healthcare providers. With regard to researchers, the HIPAA regulations have hindered their ability to perform retrospective, chart-based research as well as their ability to prospectively evaluate patients by contacting them for follow-up surveys. The HIPAA regulations have also led to significant decreases in patient accrual, increases in time spent recruiting patients, and increases in mean recruitment costs for researchers. And, by requiring that informed consent forms for research studies include extensive detail on how the participant's protected information will be kept private, those already complex documents have become even less user-friendly.

Because most EHR systems are not capable of exporting and importing patient information in a standardized format and do not utilize functions and features suited for interaction and data exchange with other systems, the fragmented pools of data collected using those systems cannot easily be combined with the ocean of data collected across a population of patients, much less a community of patients. Accordingly, collecting data across a broad swath of patients to perform medical research, to maintain disease registries, to track patient care for quality and safety initiatives, and to perform composite clinical and financial analytics remains a time-consuming and expensive process. For example, a clinical research organization (CRO) tasked with identifying patients that satisfy certain criteria for participating in a clinical trial must still sort through voluminous libraries of paper medical records and unstructured data, spending large amounts of time and money searching for candidates. Those problems have only been exacerbated by the regulations of HIPAA.

Solutions to the above issues are presented in U.S. Pat. Nos. 7,716,072, 8,050,938, 8,428,966, and 8,438,041, whose disclosures are hereby incorporated by reference into the present disclosure.

The '041 patent is directed to a system and method of for analyzing, collecting, and tracking patient data across a vast patient population comprising a plurality of Electronic Health Record (EHR) systems provided at a plurality of healthcare provider sites, each EHR system capturing data for a plurality of patients in real time; comprising at least one research system for generating a dataset by performing at least one of analyzing, collecting, and tracking the data captured by the plurality of EHR systems in real time as the data is captured or from a database on which the captured data is stored; and comprising at least one workstation for setting the criteria by which the research system analyzes, collects and tracks the data captured by the plurality of EHR systems and for viewing the dataset generated by the at least one research system, wherein the dataset includes the data that corresponds to each of the criteria set at the workstation.

FIG. 1 of the '041 patent is reproduced herein as FIG. 1. The '041 invention provides infrastructure and functionality for analyzing, collecting, and tracking data across a vast patient population. And, the '041 invention provides infrastructure and functionality for utilizing that data to more effectively and efficiently perform medical research, maintain disease registries, track patient care for quality and safety initiatives, and perform composite clinical and financial analytics. The '041 invention may be implemented via an integrated physician's infrastructure (IPI) 100 that includes a network of fully functional EHR systems that are built on the same architecture, such as Greenway Medical Technologies, Inc.'s IPI that includes its PRIMESUITE brand EHR systems. The IPI 100 also includes a plurality of research systems built on the same architecture as the EHR systems so data can be shared seamlessly therebetween based on integration rather than interfacing different systems together.

By integrating the infrastructure and architecture of the various systems of the IPI 100, the '041 invention provides a single-vendor solution that allows for single-vendor support and the seamless sharing of standardized data across all of those systems. Accordingly, that data can be actively analyzed, collected, and tracked across a vast patient population in real time based on triggering events rather than requiring that queries be run on passive, “stale” data housed in a data repository. Moreover, by standardizing the format in which the data is captured and stored as well as the format by which it is exchanged across all of the systems of the IPI 100, the need for “middleware” type architecture to interface the various systems is eliminated. Thus, errors, duplication, and inconsistencies in data are also eliminated by the '041 invention. And, by building all of the systems of the IPI 100 on the same architecture, each system can be upgraded as a single entity with consideration for all functionality that may be affected.

FIG. 1 illustrates an exemplary non-limiting embodiment of the infrastructure of the IPI 100 of the '041 invention. The IPI 100 is a network of computer systems comprising a plurality of EHR systems, a plurality of research systems, and at least one IPI provider system that are interconnected via a plurality of secured connections. Each EHR system is provided at a healthcare provider's site 102 and includes at least one client server 104 and at least one client workstation 106. Each research system may be provided at a researcher's site 108 and includes at least one partner server 110 and at least one partner workstation 112. And, each IPI provider system may be provided at the IPI provider's site 114 and includes at least one enhanced services server 116 and at least one administrator workstation 118. The EHR systems, research systems, and IPI provider system are all built on the same architecture so that the various systems of the IPI 100 and the functionality of each of their applications may be seamlessly integrated across the entire IPI 100.

The client server 104 of each EHR system contains all of the system applications and controls the operation of the EHR system. The client server 104 also controls communications with the other components of the IPI 100 and locally stores data collected using the EHR system. The client server 104 is at the center of the EHR system and may be located at a central location at a healthcare provider's site 102 for communication with each of the client workstations 106. In the alternative, as opposed to being hosted at the healthcare provider's site 102, all of the applications, controls, and data for the EHR system may be remotely hosted at a client server 120 located at a client data center 122. A client server 120 located at a client data center 122 may also host the applications, controls, and data for other EHR systems utilized by different healthcare providers.

The client workstations 106 provide a point of communication between healthcare providers and the client server 104 of the EHR system. The client workstations 106 of each EHR system may be provided at various locations, remote from the client server 104, throughout the healthcare provider's site 102 (e.g., in different physicians' offices). When the client server 104 is also located at the healthcare provider's site 102, the client workstations 106 communicate with the client server 104 and with each other over a Local Area Network (LAN) via a client router 124. The client server 104 and client workstations 106 of each EHR system also communicate with the enhanced services server 116 and administrator workstation 118 of the IPI provider system via a provider router 126 provided at the IPI provider's site 114, which preferably communicates with the client router 124 via a broadband network, such as DSL (“Digital Subscriber Line”), cable modem, or other high-speed connection.

When the client server 120 is provided at the client data center 122, the client workstations 106 communicate with that client server 120 via a client data center router 128 at the client data center 122 that preferably communicates with the client router 124 via a private dedicated network, such as a frame relay network. In that configuration, the client server 120 at the client data center 122 and the client workstations 106 at the healthcare provider's site 102 may also communicate with the enhanced services server 116 and administrator workstation 118 of the IPI provider system via the provider router 126 provided at the IPI provider's site 114, which communicates both with the client router 124 and the client data center router 128 via the private dedicated network. The client data center router 128 is located behind a firewall 130 to provide security from unauthorized internet access. And, use of a private dedicated network to facilitate the transmission of data when the client server 120 is provided at a location remote from the location of the client workstations 106 causes those components to perform like a private dedicated network and provides additional security to that network. Although the exemplary embodiment illustrated in FIG. 1 utilizes a broadband network when the client server 104 is provided at the healthcare provider's site 102 and a private dedicated network when the client server 120 is provided at the client data center 122, either a broadband network or a private dedicated network may be utilized in either configuration.

The partner server 110 of each research system contains all of the system applications and controls the operation of the research system. The partner server 110 also controls communications with the other components of the IPI 100 and locally stores data collected using the research system. The partner server 110 is at the center of the research system and may be located at a central location at a researcher's site 108 for communication with each of the partner workstations 112. In the alternative, as opposed to being hosted at the researcher's site 108, all of the applications, controls, and data for the research system may be remotely hosted at a partner server 132 located at a partner data center 134. A partner server 132 located at a partner data center 134 may also host the applications, controls, and data for other research systems utilized by different healthcare providers.

The partner workstations 112 provide a point of communication between researchers and the partner server 110 of the research system. The partner workstations 112 of each research system may be provided at various locations, remote from the partner server 110, throughout the researcher's site 108 (e.g., in different researchers' offices). When the partner server 110 is also located at the researcher's site 108, the partner workstations 112 communicate with the partner server 110 and with each other over a LAN via a partner router 136. The partner server 110 and partner workstations 112 of each research system also communicate with the enhanced services server 116 and administrator workstation 118 of the IPI provider system via the provider router 126 provided at the IPI provider's site 114, which preferably communicates with the partner router 136 via a broadband network.

When the partner server 132 is provided at the partner data center 134, the partner workstations 112 communicate with that partner server 132 via a partner data center router 138 at the partner data center 134 that preferably communicates with the partner router 136 via a private dedicated network. In that configuration, the partner server 132 at the partner data center 134 and the partner workstations 112 at the researcher's site 108 may also communicate with the enhanced services server 116 and administrator workstation 118 of the IPI provider system via the provider router 126 provided at the IPI provider's site 114, which communicates both with the partner router 136 and the partner data center router 138 via the private dedicated network. The partner data center router 138 is located behind a firewall 130 to provide security from unauthorized internet access. And, as discussed above, use of a private dedicated network to facilitate the transmission of data when the partner server 132 is provided at a location remote from the location of the partner workstations 112 causes those components to perform like a private dedicated network and provides additional security to that network. Although the exemplary embodiment illustrated in FIG. 1 utilizes a broadband network when the partner server 110 is provided at the researcher's site 108 and a private dedicated network when the partner server 132 is provided at the partner data center 134, either a broadband network or a private dedicated network may be utilized in either configuration.

The enhanced services server 116 of the IPI provider system contains all of the system applications used by the IPI provider to control and maintain the operation of the various systems of the IPI 100. The enhanced services server 116 also controls communications with systems outside of the IPI 100 and stores data aggregated from the various systems of the IPI 100. The enhanced services server 116 is provided at the center of the IPI 100 and can therefore serve as a centralized repository for the data aggregated from the various systems of the IPI 100. Access to that repository of data is controlled by the enhanced services server 116.

The administrator workstation 118 provides a point of communication between IPI administrators and the enhanced services server 116 and other systems within the IPI 100. The administrator workstation 118 may be provided at a location remote from the enhanced services server 116 at the IPI provider's site 114. The administrator workstation 118 communicates with the enhanced services server 116 over a LAN via a provider router 126. The enhanced services server 116 and administrator workstation 118 also communicate with the client servers 104 and client workstations 106 of the EHR systems and the partner servers 110 and partner workstations 112 of the research systems via the provider routers 126 provided at the IPI provider's site 114. As discussed above, the provider routers 126 communicate with the client routers 124, the client data center routers 128, the partner routers 136, and the partner data center routers 138 of the EHR systems and research systems, respectively, via a broadband network and/or a private dedicated network. The enhanced services server 116 can control at least one internet router 140 that is used to provide the various systems of the IPI 100 access to the internet when the client server 104 or partner server 110 do not provide such access. The internet router 140 is located behind a firewall 130 to provide security from unauthorized internet access. Administrative functionality for the applications of each system in the IPI 100 can be handled through the administrator workstation 118.

The functionality provided at each workstation 106, 112, and 118 is implemented via a single technology platform, such as web technologies that include markup languages, programming interfaces and languages, and standards for document identification and display (e.g., HyperText Markup Language (HTML), Visual Basic Script (VBScript), Extensible Markup Language (XML), Scalable Vector Graphics (SVG), JAVASCRIPT brand language, Cascading Style Sheets (CSS), Document Object Model (DOM), Virtual Reality Modeling Language (VRML), UNIX brand language, etc.). Those web technologies are utilized to provide users of the systems of the IPI 100 with web-browser-type user interfaces for communicating with the systems of the IPI 100. Accordingly, those web technologies may be used to facilitate remote access to all of the applications and data maintained by the various servers 104, 110, and 116 of the IPI 100 within a highly secured environment and enable communication between clients, partners, and administrators. Thus, substantially any device capable of employing those web technologies can be utilized as a workstation 106, 112, and 118 (e.g., a personal computer (PC), a laptop, a Personal Digital Assistant (PDA), a Secure Mobile Environment Portable Electronic Device (SME PED), etc.).

The functionality of each server 104, 110, 116, 120, and 132 of the IPI 100 is implemented via a central processor that manages the launching of script files and controls the operation of each server. Each central processor utilizes a central service utility that runs in the background and automates tasks within each system and across all of the systems of the IPI 100. Thus, the central service utility includes two types of utilities, one that runs on the individual servers 104, 110, 116, 120, and 132 of the respective systems and one that runs across all of the servers 104, 110, 116, 120, and 132 of the IPI 100.

The central service utility utilizes an event-driven design to perform tasks by monitoring a set of directories on the various servers 104, 110, 116, 120, and 132 of the IPI 100 and identifying the presence of an event or flag file before initiating, or triggering, an associated script or application. Multiple scripts and flags can be used together to complete tasks, and each task may consist of multiple scripts and/or third party programs. An event may include an empty file, a file comprising a single line of data, or a complete data file; and a flag file contains data that indicates what task is to be performed based on the event.

The central service utility supports tasks performed by standard internet-based services (e.g., Internet Information Services (IIS) and Active Server Page Network (ASP.NET) services) and standard software-framework-based services (e.g., Component Object Model Plus (COM+) and .NET services). The internet-based services provide functionality for the robust, interactive data exchange processes of the '041 invention, and provide functionality for presenting data to users of the various systems of the IPI 100 in a web-browser-type format. The software-framework-based services provide functionality for centrally managing all of the business logic and routines utilized by the '041 invention.

Each of the servers 104, 110, 116, 120, and 132 of the IPI 100 also include functionality for managing a relational database. Each database utilizes relational technology (e.g., a Relational Database Management System (RDBMS)) to manage all discrete data centrally, which facilitates the seamless sharing of information across all applications within each system of the IPI 100. And, by using standardized medical vocabularies to normalize data within each system of the IPI 100, information can also be shared seamlessly across the various systems of the IPI 100. That functionality reduces the potential for redundant data entry and data storage at the client server 104, 120 and partner server 110, 132 as that data is captured, and at the provider server 116 as that data is aggregated from the other servers. In addition, by storing data in relational databases, that data can be more efficiently queried to produce de-identified data sets.

To further facilitate the efficient querying of data, each database also utilizes standardized database languages designed for the retrieval and management of data in relational database, such as the Structured Query Language (SQL) and XML-Related Specifications (e.g., SQL/XML). Those standardized database languages are used to assign normalized extensions to particular types of data so that data can be more easily located within a database. And, in addition to standard extensions provided as part of those languages, those languages can also be used to define proprietary extensions unique to the system in which they are employed. Accordingly, the '041 invention provides functionality for storing data in a meaningful way that provides fast, easy access by any system in the IPI 100, which further enhances the data querying capabilities of the '041 invention.

In a preferred embodiment, the functionality provided at each workstation 106, 112, and 118 and each server 104, 110, 116, 120, and 132 of the IPI 100 is implemented using a tiered architecture. For example, the functionality of the workstations 106, 112, and 118 may be implemented in a user tier; the functionality of the central service utility of the servers 104, 110, 116, 120, and 132 may be implemented in a business tier; and the functionality of the databases of the servers 104, 110, 116, 120, and 132 may be implemented in a data tier. Accordingly, both a data tier and a business tier are located on each server 104, 110, 116, 120, and 132, while a client tier is located on each workstation 106, 112, and 118. In that configuration, the business tier is the middle tier and utilizes its standard internet-based services and standard software-framework-based services to analyze, collect, and track the data in the data tier and present it to a user of the IPI 100 at the user tier. The business tier may access the data in the data tier using a set of computer software components provided as part of the software-framework-based services (e.g., ADO.NET), and may transmit that data to the client tier using application-level protocol for the internet-based services (e.g., Hypertext Transfer Protocol Secure (HTTPS)).

That architecture may be based on Microsoft Corporation's Distributed Internet Applications (DNA) architecture, which uses .NET objects and Web Services for business rules and COM+ for resilient database storage and retrieval. Using the DNA architecture, the user tier would utilize Microsoft Corporation's Smart Client software as the client platform; the business tier would be implemented on Microsoft Corporations WINDOWS 2008 brand server using IIS, ASP.NET, Microsoft Corporation's Component Service, and .NET middle-tier objects; and the data tier would implement Microsoft Corporation's SQL*Server. Such a standard n-tier design model provides separation of the detailed business rules from the data storage functionality at the data tier and data presentation functionality at the user tier. In the '041 invention, such architecture also provides for tighter integration of the functionality within each system of the IPI 100.

In addition, the integrated architecture of the '041 invention enables a single source of support to minimize the cost of ongoing system maintenance and provides a scalable solution that allows the various systems of the IPI 100 to be expanded or contracted for large healthcare communities or specific healthcare specialties, respectively. Moreover, providing a single-vendor solution on a single technology platform in that manner allows the IPI provider to push new or updated system software to all of the systems in the IPI 100 simultaneously whenever that software is replaced or revised, thus ensuring seamless data exchange across all of those systems.

To further facilitate the seamless exchange of data across all of those systems, each of the various systems of the IPI 100 may utilize a controlled medical vocabulary, such as the Systematized Nomenclature of Medicine, Clinical Terms (SNOMED CT). SNOMED CT is a scientifically validated collection of well-formed, machine-readable, and multi-lingual healthcare terminology that provides a standardized nomenclature for use in capturing, indexing, sharing, and aggregating healthcare data across specialties and sites of care. Because the common language employed by SNOMED CT reduces the variability in the way data is captured, encoded, and used, it is particularly suited for use in electronic medical records, ICU monitoring, clinical decision support, medical research studies, clinical trials, computerized physician order entry, disease surveillance, image indexing, and consumer health information services. SNOMED CT is currently maintained by the International Health Terminology Standards Development Organization (IHTSDO).

The '041 invention also utilizes other standardized medical terminologies and classification systems, such as the International Classification of Diseases (ICD), RxNorm, Logical Observation Identifiers Names and Codes (LOINC), and Current Procedural Terminology (CPT). ICD is a coded classification system for identifying the signs, symptoms, abnormal findings, complaints, social circumstances, and external causes of various injuries and diseases, and it is currently maintained jointly by the National Center for Health Statistics (NCHS) and the Centers for Medicare & Medicaid Services (CMS). RxNorm is a coded classification system for identifying clinical drugs and doses administered to patients, and it is currently maintained by the National Library of Medicine (NLM). LOINC is a coded classification system for identifying laboratory and clinical observations, and it is currently maintained by the Regenstrief Institute, Inc. And, CPT is a coded classification system for describing medical, surgical, and diagnostic procedures, and it is currently maintained by the American Medical Association (AMA). By using those standardized nomenclatures, the '041 invention avoids duplicate data capture while facilitating enhanced health reporting, billing, and statistical analysis. And, by mapping each of those standardized nomenclatures to the SNOMED CT vocabulary, duplicate data capture is further avoided while providing a framework for managing different language dialects, clinically relevant subsets, qualifiers and extensions, as well as concepts and terms unique to particular organizations or localities.

The '041 invention maintains each of those standardized nomenclatures across all of the systems of the IPI 100 in an extensive “back-end” repository so that they can not only be mapped to data captured by those systems, but can also be mapped to other widely accepted coded classification systems to further improve the functionality of the '041 invention. For example, ICD codes can be mapped to associated CPT codes for claims processing, CPT codes can be mapped to result codes from various laboratories to facilitate lab interactions, and RxNorm codes can be mapped to First DataBank, Inc.'s NATIONAL DRUG DATA FILE PLUS (NDDF PLUS) brand coded classification system to facilitate pharmacy management and drug interaction analysis. In addition to normalizing data throughout the IPI 100 to eliminate duplicate data capture and to streamline the sharing of data, the use of all of the standardized nomenclatures described herein also allows the various systems of the IPI 100 to more easily mediate inbound and outbound data communications with external information systems 142 outside of the IPI 100. External information systems 142 include, but are not limited to, external EHR systems, external research systems, disease registry systems, public health organization systems, safety/quality organization systems, and claims processing systems.

When the systems of the IPI 100 must interface with external information systems 142 to facilitate the exchange of data in real time, the '041 invention includes an interoperability engine to facilitate integration with such external information systems 142. The interoperability engine supports various standardized formats as well as various vendor-specific delimited files and fixed width files. Thus, instead of relying on distributed interfaces to various applications, the '041 invention provides a single platform maintained on the secure, managed network infrastructure of the IPI 100, thereby extending the seamless exchange of data across the various systems of the IPI 100 to include external information systems 142.

For example, the interoperability engine supports a uniform messaging standard, such as the Health Level Seven (HL7) messaging standard, for identifying triggering events and the associated data that is to be exchanged based on the triggering event. In the '041 invention, a triggering event includes an event at a client's site 102 or a partner's site 108 that creates the need for data to flow among systems, such as registering a new patient at a client's site 102 or submitting available clinical trials at a partner's site 108. Among the external information systems 142 that can be interfaced in real time using the HL7 messaging standard are EHR systems that include diagnostic equipment for capturing data at the point of care. Accordingly, the systems of the IPI 100 can exchange information such as patient demographics, processing pre-certifications, orders, results, labs, and prescriptions with external information systems 142 in real time based on triggering events. The HL7 messaging standard is utilized by most healthcare information systems, such as the hospital information systems provided by McKesson HBOC Inc., Meditech Inc., and Cerner Corp. The contents of the HL7 messaging standard are hereby incorporated by reference.

In addition to supporting a uniform messaging standard for the real-time exchange of data with external information systems 142, the interoperability engine of the '041 invention also supports a uniform document standard, such as the Continuity of Care Document (CCD) standard, for specifying the structure and semantics of electronic documents in which data is captured. The CCD standard is a structured Extensible Markup Language (XML) standard developed by HL7 and the American Society for Testing and Materials (ASTM) to harmonize the data format between HL7's Clinical Document Architecture (CDA) standard and ASTM's Continuity of Care Record (CCR) standard. The CDA standard provides an exchange model for clinical documents (e.g., discharge summaries and progress notes) that uses various coded vocabularies (i.e., the coded vocabularies discussed above, such as ICD, etc.) to assign both computer-readable structured components and human-readable textual components to electronic documents so those documents can be easily parsed and processed electronically and retrieved, read, and understood by the people who use them. And, the CCR standard provides patient health summary model for clinical documents by identifying the most relevant and timely core health-related information about a patient so that information can be sent electronically from one healthcare provider to another. Thus, the CCD adds content to the exchange model of the CDA by using the summary model of the CCR to identify the various sections of the clinical document that collectively represent a “snapshot” of a patient's information, such as the patient's demographics, insurance information, diagnosis, problem list, medications, allergies, and care plan. Accordingly, the CCD standard supports more streamlined exchanges with and between EHR systems than supported by the CDA and CCR standards alone. The contents of the CCD standard are hereby incorporated by reference.

Supported by the CCD document standard, the interoperability engine of the '041 invention also supports a uniform form management standard, such as the Retrieve Form for Data Capture (RFD) form management standard, to facilitate the retrieval, completion, and submission of forms between the systems of the IPI 100 and with external information systems 142. The RFD standard was developed through a joint effort between the Integrating the Healthcare Enterprise (IHE) and Clinical Data Interchange Standards Consortium (CDISC) organizations to advance public health by providing a standardized means for retrieving and submitting forms data between researchers and healthcare providers and electronic data capture systems and other data collection agencies. The RFD standard makes medical research and healthcare more efficient by providing a method for capturing data within a user's current application in a manner that meets the requirements of an external system. The RFD standard supports the retrieval of forms from a Form Manager, display and completion of a form by a Form Filler, and return of instance data from the display application to a Form Receiver and a Form Archiver.

A Form Manager is responsible for providing the desired form, such as the Food and Drug Administration (FDA). A Form Filler is responsible for inputting data into the form, such as the user of an EHR system. A Form Receiver is responsible for receiving the primary data input by the Form Filler for processing purposes. And, a Form Archiver is responsible for receiving the data input from the Form Filler for archival purposes. The Form Receiver and Form Archiver may or may not be the same entity as each other, the Form Manager, or the Form Filler. The contents of the RFD standard are hereby incorporated by reference.

In addition to facilitating integration with external information systems 142, the CCD document standard and RFD form management standard can also be utilized within each system of the IPI 100 to facilitate the seamless exchange of data between those internal systems. Thus, the '041 invention provides a computer-based production environment that utilizes the CCD document standard and RFD form management standard to collect patient information in real time at the point of care using a plurality of EHR systems, both those that are part of the IPI 100 and those that are external to the IPI 100. Moreover, by facilitating the integration of external information systems 142 with the systems of the IPI 100 using the standardized formats supported by the interoperability engine, the '041 invention provides functionality for a researcher to collect medical data across an even larger patient population than that covered by various systems of the IPI 100.

In addition, utilizing those standardized medical terminologies and classification systems facilitates both systematic and data-level integration across each of the systems of the IPI 100 such that the research functionality of the research systems is seamlessly integrated into the workflows of the EHR systems, which eliminates duplicate data entries between the EHR systems and the electronic source documentation of the research systems. And, because the IPI 100 of the '041 invention includes a network of EHR systems that are built on the same architecture as the research systems, that research functionality can be employed seamlessly across the entire IPI 100 to simultaneously collect data from all of the EHR systems and electronically transfer the collected data to the research systems, which benefits all stakeholders by decreasing the input time and increasing the accuracy of data. Moreover, by providing an interoperability engine that integrates those systems with external information systems 142, the research functionality of the '041 invention can also be employed seamlessly across external research systems 142 to exchange data with external EHR systems and external research systems. Accordingly, that data can easily be exchanged with data from other clinicians, research institutes, universities, and pharmaceutical companies for broad-based ongoing research and can be used by researchers, scientists, and physicians to better understand and combat health issues and diseases.

Each system of the IPI 100 also includes features that address all of the security, privacy, and transactional regulations of the Health Insurance Portability and Accountability Act (HIPAA). To address HIPAA's security regulations, each system of the IPI 100 may include biometric login; restricted access based on login authorization (e.g., restricting access to only individual charts or chart sections); routine and event-based audits to identify potential security violations (e.g., identify who looked at what section of a chart and when); and restricted ability to copy, print, fax, e-mail, and export information based on login authority. To address HIPAA's privacy regulations, each system of the IPI 100 may include functionality for consent tracking and disclosure logging, functionality for de-identifying data, and functionality for automatically populating consent forms with the extensive details required by HIPAA explaining how a participant's protected information will be kept private. And, to address HIPAA's transactional regulations, each system of the IPI 100 may utilize Electronic Data Interchange (EDI) standards to structure the electronic transfer of claim billing information between the systems of the IPI 100 and external information systems 142, such as a claims processing system. The contents of HIPAA are hereby incorporated by reference.

By providing automated compliance with many of the requirements of HIPAA, the '041 invention helps resolve many of the intricacies of HIPAA, which alleviates much of the concern healthcare providers have had with the complex legalities and potentially stiff penalties associated with HIPAA. In addition, by providing a system that streamlines and automates the electronic capture and flow of data between healthcare providers in a secured manner, the '041 invention also eliminates much of the additional paperwork and labor associated with HIPAA, which reduces the amount of cost, time, and physical space required of healthcare providers to comply with HIPAA. And, by providing a single-vendor IPI 100 comprising a large number of integrated EHR systems and research systems, the '041 invention provides access to data for a vast patient population that can be used in clinical trials, disease registries, evidence-based medical and pharmaceutical research, and clinical and financial statistical analysis. Accordingly, the '041 invention makes it easier for researchers to recruit patients for research by reducing the time and costs associated with recruiting those patients, which not only overcomes many of the research related problems associated with existing paper-based processes and the regulations of HIPAA, but also provides a mechanism for healthcare providers to increase revenue and foster the ongoing improvement in quality of care for patients through their participation in the research facilitated by the '041 invention.

By way of further non-limiting example, the research functionality of the '041 invention may be used to quickly and accurately locate a large number of patients for participating in a clinical trial by running a sequential filtering process across the systems of the IPI 100. By utilizing an IPI 100 that includes a large network of EHR systems built on the same architecture, the filtering process can be run quickly and accurately across the databases on each client server 106 and/or querying a central database on the enhanced services server 116. And, where the IPI 100 is employed on a national scale, the results of that filtering process provide a larger pool of patients, and therefore a more desirable cross-section of people, from which researchers can recruit participants for clinical trials. For example, utilizing the '041 invention over Greenway Medical Technologies, Inc.'s IPI will currently provide researchers access to data for more than fourteen million active patients collected at more than eight hundred sixty healthcare provider sites across at least forty-seven U.S. states. Collecting, tracking, and analyzing data on such an expansive scale is indicative of the '041 invention's functionality.

Thus, a clinical trial sponsor, such as a pharmaceutical company, can utilize the '041 invention to quickly and accurately identify and register patients that qualify for clinical trials. The clinical trial sponsor can become a partner with the IPI provider and utilize the functionality of the '041 invention to locate patients within the IPI 100 network that qualify for a clinical trial, or the clinical trial sponsor can solicit proposed clinical trials through Clinical Research Organizations (CROs) who will become partners of the IPI provider and utilize the functionality of the '041 invention to locate patients within the IPI 100 network that qualify for a proposed clinical trial. To utilize that functionality, the clinical trial sponsor or CRO will develop specific clinical criteria that patients must satisfy to qualify for participation in the clinical trial. Those criteria are given to the IPI provider, who utilizes the '041 invention to run a sequential filtering process 300 and determine the number of patients within the network of the IPI 100 that qualify for the clinical trial. In the alternative, the clinical trial sponsor or CRO may utilize the '041 invention to run the sequential filtering process. But, before a clinical trial sponsor or CRO obtains access to the network of the IPI 100 and/or the data captured thereon, the clinical trial sponsor or CRO must register as a research partner of the IPI provider and agree to certain provisions to ensure compliance with HIPAA's regulations.

However, such a system does not address the specific needs of labor and delivery staff.

### SUMMARY OF THE INVENTION

It is therefore an object of the invention to address those needs.

To achieve the above and other objects, the present invention is directed to a remote labor and delivery service project that provides details captured from one or more encounters. Essentially, it is the assembly of records aggregated over the course of the duration of the patient's visits but viewable remotely by a secure portal. The Labor and Delivery user will be able to select a patient from a group of pregnant women and select a specific pregnant patient. In some embodiments, the provider will be able to view the patient's prenatal flow sheets, prenatal lab, and antepartum summary. In other embodiments, the site can choose to allow users of the Labor and Delivery system access to view other documents available for selection in the community document list (CDL) in the PrimeDATACLOUD.

The business context of the Remote Labor and Delivery Service project is to provide Labor and Delivery staff access to documentation surrounding pregnancy details captured from one or more encounters. The documents will include more than just the prenatal flow sheets, prenatal lab, and antepartum summary but to include lab notes and progress notes and other documents found in the CDL.

The high-level process includes aggregating all of the patient documentation to correlate patient information from the PrimeDATACLOUD.

The system provides functionality to allow the patient record to be shared across multiple organizations.

The system can market to clients that wish to allow physicians to view all of their patients' records among various sites utilizing a single reference index.

Remote labor and delivery related documentation can be entered via Greenway Medical Technologies PrimeSUITE product and Data must exist in the PrimeDATACLOUD.

The architecture built into the CDL selection will allow for other PrimeDATACLOUD services to utilize the functionality to select documents to view in other products.

The following terms are used in the present disclosure:

Antepartum Summary—Lists the patient details such as the following:
Patient Detail,
Allergies,
Advance Directives,
Plan of Care, Medications,
Problems,
Estimated Due Dates,
Family History, etc.

The Antepartum Record Profile (APR) is based on data elements from prenatal records currently in common use, and includes the following documents:
Antepartum History & Physical—The initial assessment and physical
Antepartum Summary—Summary of the most critical information
Antepartum Laboratory—Laboratory Evaluations
Antepartum Education—Education Record
Additional commonly used forms not included in this profile are:
A patient generated obstetric medical history
A postpartum form

A sample form showing the data elements may be found at: http://www.acog.org/acb-custom/aa128.pdf. This profile is fully supported by the American College of Obstetricians and Gynecologists (ACOG).

This profile defines the implementation of HL7 CDA documents to represent these data elements along with the XDS, XDR and XDM.

Prenatal Flowsheet—Lists the information specific to pregnancy such as encounter history, OB problem lists, ultrasounds and other pregnancy specific information.

### BRIEF DESCRIPTION OF THE DRAWINGS

A preferred embodiment of the present invention will be set forth in detail with reference to the drawings, in which:

FIG. 1 is a schematic diagram showing a system on which the preferred or another embodiment can be implemented;

FIG. 2 is a screen shot showing a desktop user interface;

FIG. 3 is a screen shot showing a list of patient charts;

FIGS. 4 and 5 are screen shots showing the reduction of a user's permission settings;

FIG. 6 is a screen shot showing a link to the document viewer;

FIG. 7 is a screen shot showing the document list accessed through the link of FIG. 6;

FIGS. 8-11 are screen shots showing a user administration tab in use;

FIG. 12 is a screen shot showing a labor and delivery nurse view;

FIGS. 13-17 are screen shots showing a search for a patient;

FIG. 18 is a screen shot showing a patient's antepartum summary;

FIG. 19 is a screen shot showing a document list; and

FIG. 20 is a screen shot showing a display of a document.

### DETAILED DESCRIPTION OF THE PREFERRED EMBODIMENT

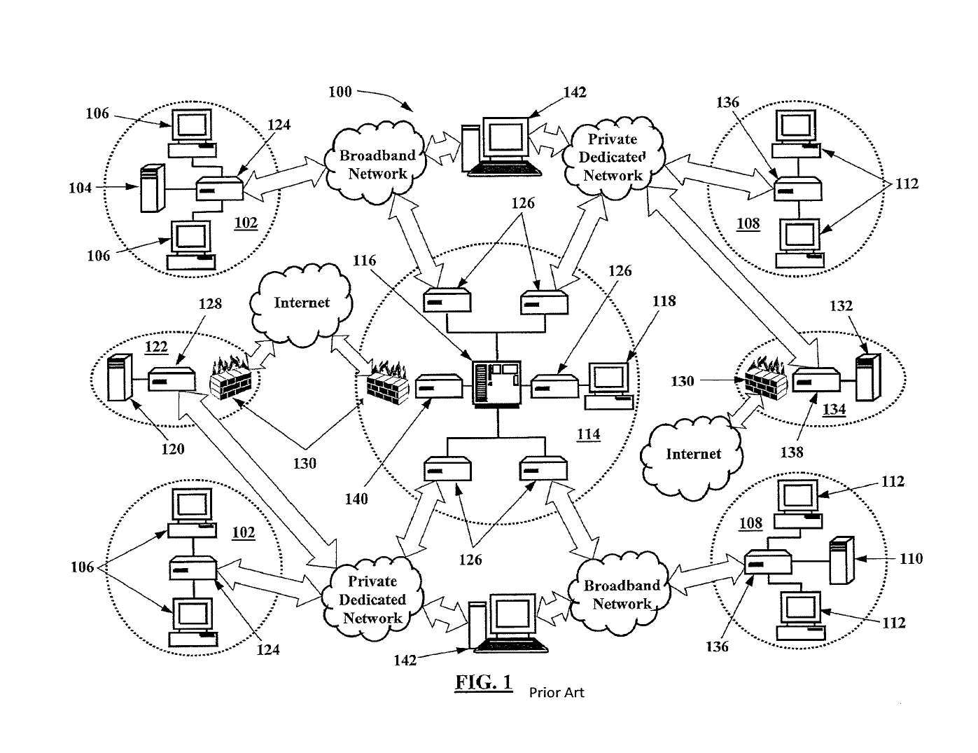

A preferred embodiment will be disclosed in detail with reference to the drawings, in which like reference numerals refer to like elements or steps throughout. The present invention can be implemented on the system of FIG. 1 or on any other suitable system.

The business context of the Remote Labor and Delivery Service project is to provide Labor and Delivery staff access to a PrimeSUITE patient's pregnancy details captured from one or more encounters. The labor and delivery staff can view these documents from the hospital. This is one of many services that may be utilized in the PrimeDATACLOUD. The site can choose documents from the community document list from PrimeDATACLOUD to view from the web or labor and delivery room.

A consistent connection can be provided from the mother as a PrimeSUITE patient to the newly born infant, who becomes a PrimeSUITE patient at the time of birth. A delivery record can be produced.

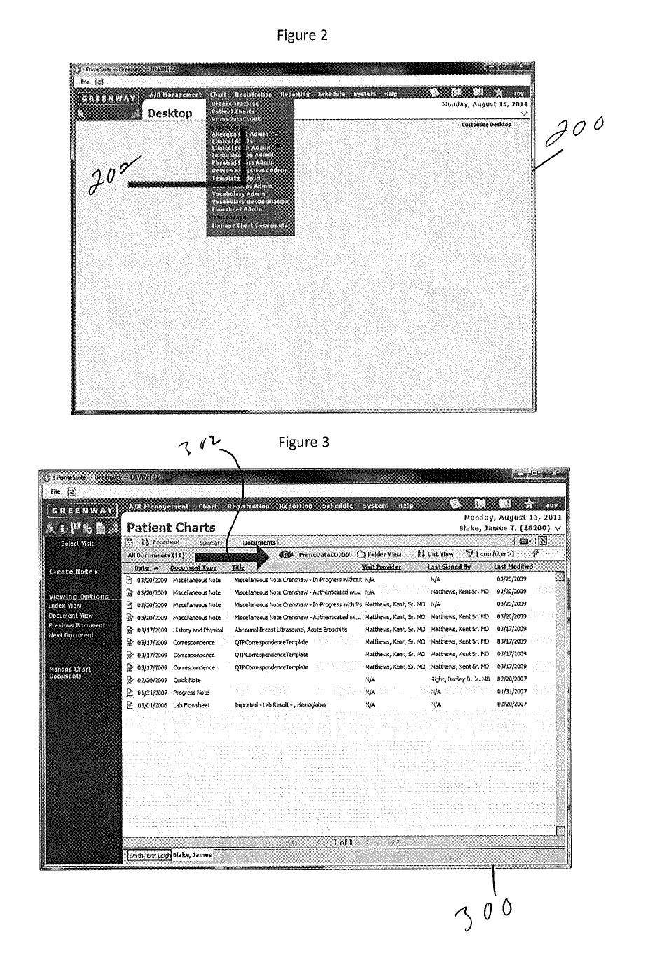

Two additions are made to the user interface of an existing system. First, as shown in FIG. 2, “System Setup” options 202 are added to a desktop user interface 200. Those options can be used in the manner described below. Second, as shown in FIG. 3, a link 302 is provided from the PrimeSUITE Chart 302 to PrimeDATACLOUD. The purpose of this functionality is to allow the user to enter the PrimeDATACLOUD portal and begin to view the longitudinal patient records. The information will be carried from the clinical document list in the Patient Chart 300 to the PrimeDATACLOUD. Table I provides the details of the link.

TABLE I

| | Control | | |
|---|---|---|---|
| Label Name | Type | Behavior/Rules | Comments |
| PrimeDATACLOUD | Link | Required Field: No | New |
| | | Pre-fill/Default: Default is a | |
| | | link not listed for non- | |
| | | authorized users. Users must | |
| | | be set up to have access to | |
| | | the link. | |
| | | Behavior: When the user | |
| | | clicks the link, a webpage will | |
| | | appear that gives the user | |
| | | options to choose various | |
| | | logically grouped categories. | |
| | | “Enterprise” is the grouping | |
| | | that contains the Document | |
| | | Viewer link. | |
| | | Integration: There is a | |
| | | seamless integration | |
| | | between PrimeSUITE and | |
| | | the PrimeDATACLOUD | |
| | | Portal Application | |
| | | Boundaries: N/A | |
| | | Validation: An error will | |
| | | appear on the webpage if the | |
| | | site does not load properly. | |
| | | User Rights: Users must be | |
| | | set up to have access to the | |
| | | link. | |

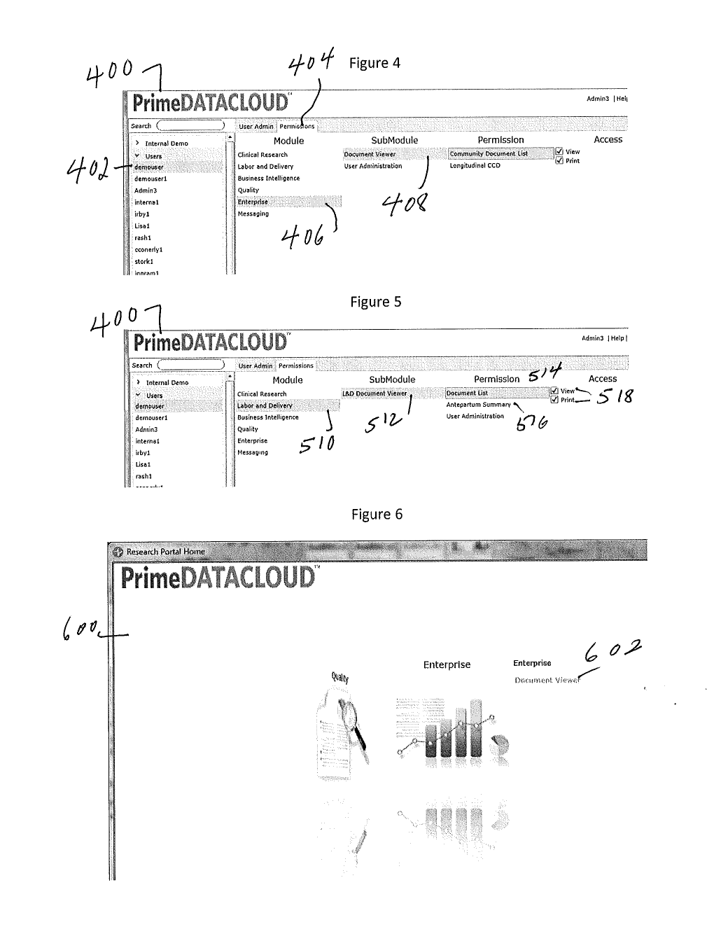

When setting user options, the administrator can reduce any user's permission settings to only show Labor and Delivery in a manner that will now be explained with reference to FIGS. 4 and 5. In the user administration screen 400, the administrator selects User Name 402, Permissions Tab 404, Enterprise 406, Document Viewer 408, Labor and Delivery 510, and L&D Document Viewer 512. The administrator can allow the user to view either or both of the Document List 514 and the Antepartum Summary 516 by using check boxes 518. In that manner, different permissions can be granted to different users.

A user, once granted permission, may access the PrimeDATACLOUD Portal Enterprise Portlet from the patient chart by selecting the PrimeDATACLOUD link. Once in the PrimeDATACLOUD home page, shown in FIG. 6 as 600, the user can access the Document Viewer through a link 602. See Tables II and III.

TABLE II

| | Control | | |
|---|---|---|---|
| Label Name | Type | Behavior/Rules | Comments |
| Document | Link | Required Field: “Yes” users must have | New |
| Viewer | | ability to view the longitudinal patient | |
| | | records | |
| | | Pre-fill/Default: Default is enabled | |
| | | Behavior: All users with rights to the | |
| | | PrimeDATACLOUD have the | |
| | | Document | |
| | | Viewer link enabled. | |
| | | Integration: New screens for Document | |
| | | Viewer will be loaded. | |
| | | Boundaries: N/A | |
| | | Validation: N/A | |
| | | Audit Log: See audit log section below | |
| | | User Rights: See Page Load Logic | |

TABLE III

| Auditable Action | Logged Information |
|---|---|
| Login Recorded | Date: Current date/time |
| | Component: PrimeDATACLOUD Portal |
| | Subcomponent: Quality |
| | Action: New |
| | Description: User < > has logged in to the |
| | PrimeDATACLOUD portal. |

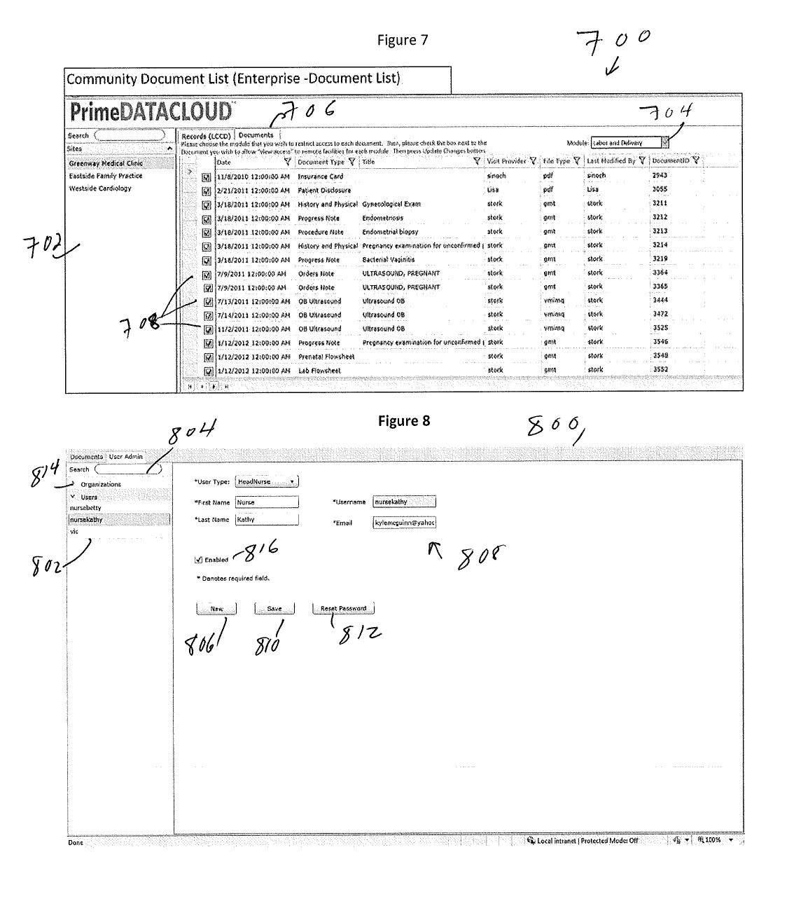

The Document Viewer screen is shown in FIG. 7 as 700. A user has the ability to choose documents for a specific site to view by choosing the site in the list 702 on the left of the screen. The “Module” dropdown 704 includes Labor and Delivery. The “Documents” tab 706 now includes checkmarks 708 to allow the user to choose which documents to make viewable in the module selected above. The fields are as explained in Table IV.

TABLE IV

| Label Name | Control Type | Description |
|---|---|---|
| Checkbox | Checkbox | Action: User clicks the checkbox to make |
| | | viewable in the module (Labor and Delivery |
| | | in this case) the document selected. |
| | | Expected result: User checks box next to the |
| | | document in CDL and the document shows |
| | | up in the Labor and Delivery module. |
| Module | Dropdown | Action: User clicks the dropdown box and |
| | | may choose/highlight a specific module to |
| | | apply the document view capability |
| | | Expected result: User should see the screen |
| | | refreshed to show documents checked that are |
| | | to be viewed within the module defined in the |
| | | dropdown list box. If the dropdown changes, |
| | | the page refreshes to show the documents |
| | | checked that are to be viewed within the |
| | | changed module. |

The “User Admin” tab 800 of FIG. 8 allows an L&D administrator to add other L&D users (other administrators and/or nurses) to have access to the L&D portal so that they may view a pregnant patient's medical documents as needed for L&D. An administrator is also able to select from a list 802 of existing L&D users to view or edit their information. A user is able to utilize a search tool 804, described in Table V, to navigate through the list of users in order to locate needed information easily.

TABLE V

| Label Name | Control Type | Description |
|---|---|---|
| Search | Text Box | Action: User types in a key word into the |
| | | search box. |
| | | Expected result: A list of matching users |
| | | appears underneath the box. |

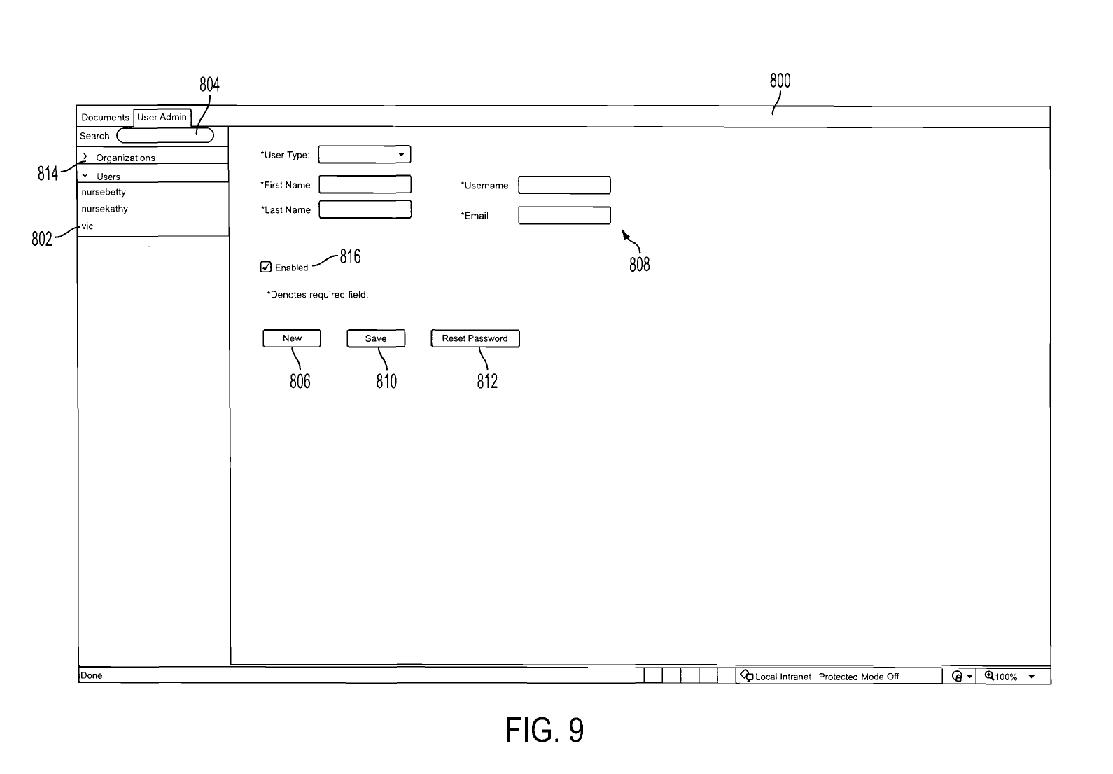

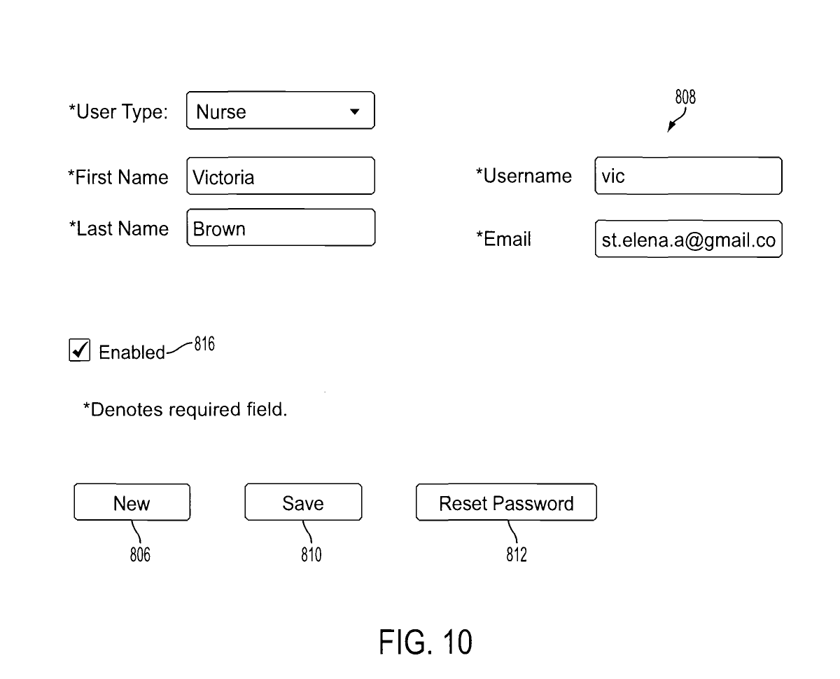

To clear all fields on the screen, the administrator must click on the “New” button 806. Once all the fields are cleared, as shown in FIG. 9, the administrator may enter required information for a new user. To create a new user, the administrator must enter information to all the required fields 808, as shown in FIG. 10, and click on “Save” button 810. There is also a “Reset Password” button 812. The buttons are described in Table VI.

TABLE VI

| | Control | |
|---|---|---|
| Label Name | Type | Description |
| New | Button | Action: User clicks on “New” button. |
| | | Expected result: All fields are cleared and user is |
| | | now able to enter new user's information. |
| Save | Button | Action: User clicks on “Save” button. |
| | | Expected result: User's information is saved and |
| | | appears on the user list on the left side of the screen. |
| User Type | Drop- | Action: Admin selects “Nurse” form the menu. |
| | down | Expected result: User will be given access to |
| | menu | “Medical Documents” tab within L&D. |
| | | Action: Admin select “Head Nurse” from the menu. |
| | | Expected result: User will be given access to |
| | | “Medical Documents” tab and “User Admin” tab. |
| First Name | Text | Action: Administrator types in new user's fist name |
| | Box | in the box. |
| | | Expected result: Entered name will be associated |
| | | with the user in database. |
| | | Note: “First Name” is a required field limited to 50 |
| | | characters in length. |
| Last Name | Text | Action: Administrator types in new user's last name |
| | Box | in the box. |
| | | Expected result: Entered name will be associated |
| | | with the user in database. |
| | | Note: “Last Name” is a required field limited to 50 |
| | | characters in length. |
| Email | Text | Action: Administrator enters new user's email |
| | Box | address in the box. |
| | | Expected result: An email with the new user's |
| | | username and temporary password will be sent to |
| | | the entered address. |
| | | Note: Entered text should contain “@” character |
| | | for the system to accept it as an email address. |
| | | “Email” is a required field limited to 50 characters |
| | | in length. |
| Enabled | Check | Action: Administrator checks the box before saving |
| | Box | new user's information. |
| | | Expected result: The new created user will be able |
| | | to access PrimeDATACLOUD portal. |
| | | Action: Administrator leaves the box unchecked |
| | | (default). |
| | | Expected result: The newly created user will not be |
| | | able to access Research Portal. |

The system will generate a message notifying the administrator that a new user was added to the portal and that an email has been sent to the user with the user's login ID and temporary password.

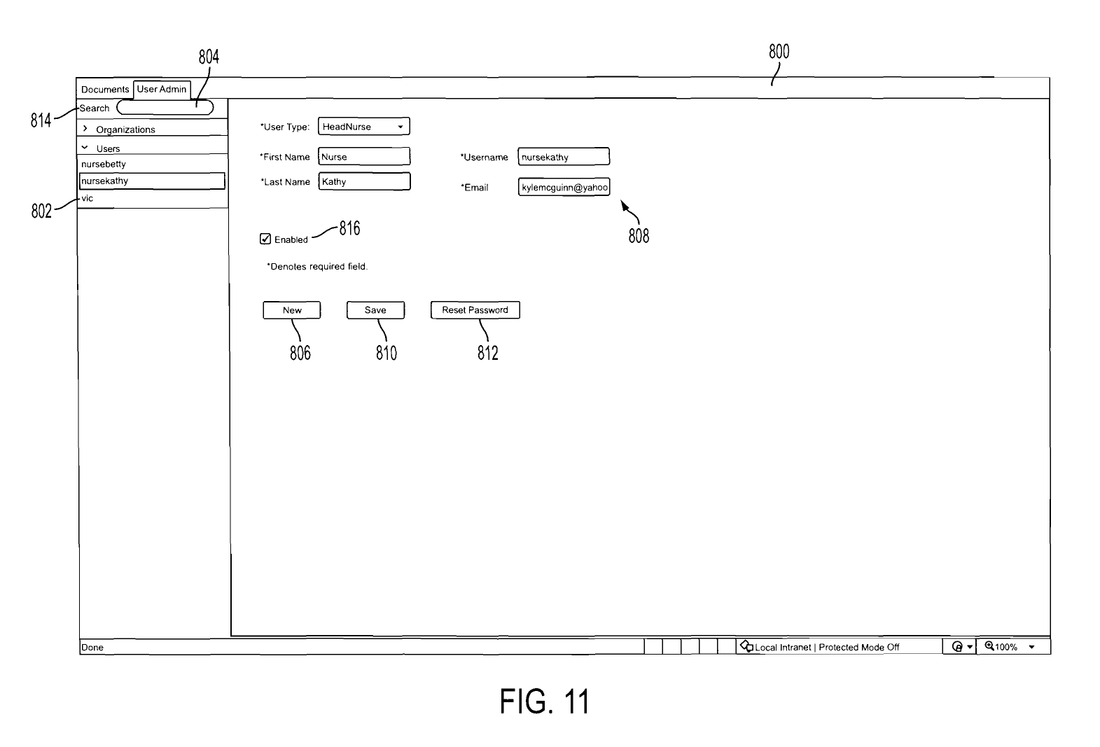

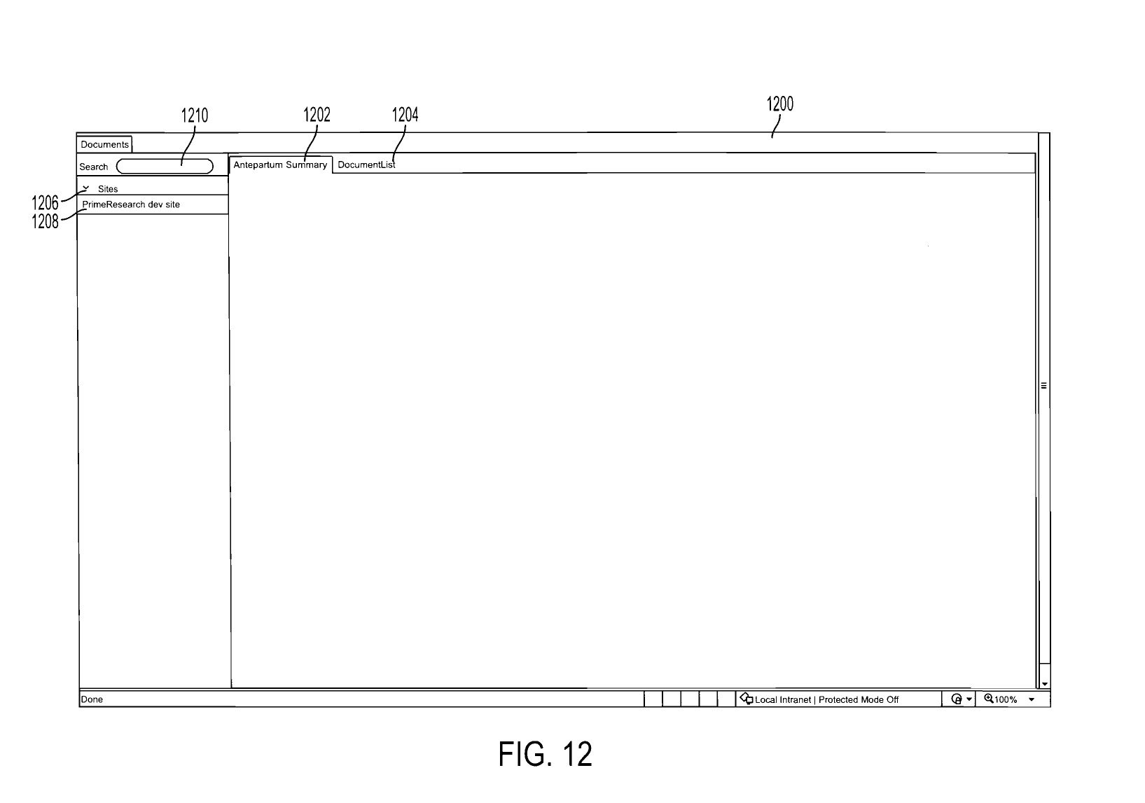

Once a new user is added, the created username will appear on the list on the left side of the screen, as shown in FIG. 11, and the administrator will be able to view or edit the user's information. To view a list of existing users, the administrator must select “Organization” from a menu 814 on the left side of the screen by clicking on it. To view or edit an existing user's information, the administrator must select a user from the list on the left side of the screen. The selected user's information will be populated in the fields, allowing the administrator to edit the user's data. After all needed changes are made, the administrator must click on the “Save” button to push the new data into the database.

To enable/disable an existing user, the administrator must check/uncheck the “Enabled” check box 816 and click on the “Save” button. The system will generate a message notifying the administrator that the user's information has been updated.

To reset an existing user's password, the Administrator must select the user from the list on the left side of the screen and click on the “Reset Password” button. The system will generate a confirmation request asking if the Administrator wants to reset the user's password. After the “OK” button is clicked, the confirmation request window the system will generate a message notifying about the event.

Other system messages are disclosed in Table VII.

TABLE VII

| Message | Action | Description |
|---|---|---|
| “Please enter first name.” | User leaves “First | Ok: User is |
| | Name” field blank | returned to the |
| | when creating | new user screen. |
| | new user or | All previously |
| | editing an existing | entered fields are |
| | user's | restored. |
| | information. | |
| “Please enter last name.” | User leaves “Last | Ok: User is |
| | Name” field blank | returned to the |
| | when creating | new user screen. |
| | new user or | All previously |
| | editing an existing | entered fields are |
| | user's | restored. |
| | information. | |
| “Please enter a valid username.” | User leaves | Ok: User is |
| | “Username” field | returned to the |
| | blank when | new user screen. |
| | creating new user | All previously |
| | or editing an | entered fields are |
| | existing user's | restored. |
| | information. | |
| “Please enter a valid email address.” | User leaves | Ok: User is |
| | “Email” field | returned to the |
| | blank when | new user screen. |
| | creating new user | All previously |
| | or editing an | entered fields are |
| | existing user's | restored. |
| | information. | |

The Labor and Delivery Nurse view, shown in FIG. 12 as 1200, will now be described. The Labor and Delivery Nurse is only able to see documentation such as the Antepartum Summary 1202, the Prenatal Flowsheets, and the Prenatal Lab Flowsheets for pregnant patients for sites they have access to view. The documents from the Document List 1204 are printable once opened.

To navigate through and select from a list of sites that are appointed to the organization, a user must click on the “Sites” tab 1206 and select a site from the list 1208. The user is able to utilize a search tool 1210 to navigate through the list of sites in order to easily locate needed subjects. Table VIII discloses details of the user interface.

TABLE VIII

| Label Name | Control Type | Description |
|---|---|---|
| Documents | Tab | Shows search box, Sites Accordion, |
| | | Antepartum Summary Tab, and Document |
| | | List Tab |
| Search | Text Box | Action: User types in a key word into the |
| | | search box. |
| | | Expected result: A list of matching sites |
| | | appears underneath the box. |
| Sites | Accordion List | Lists all of the sites that the user has access |
| | | approval to view. |

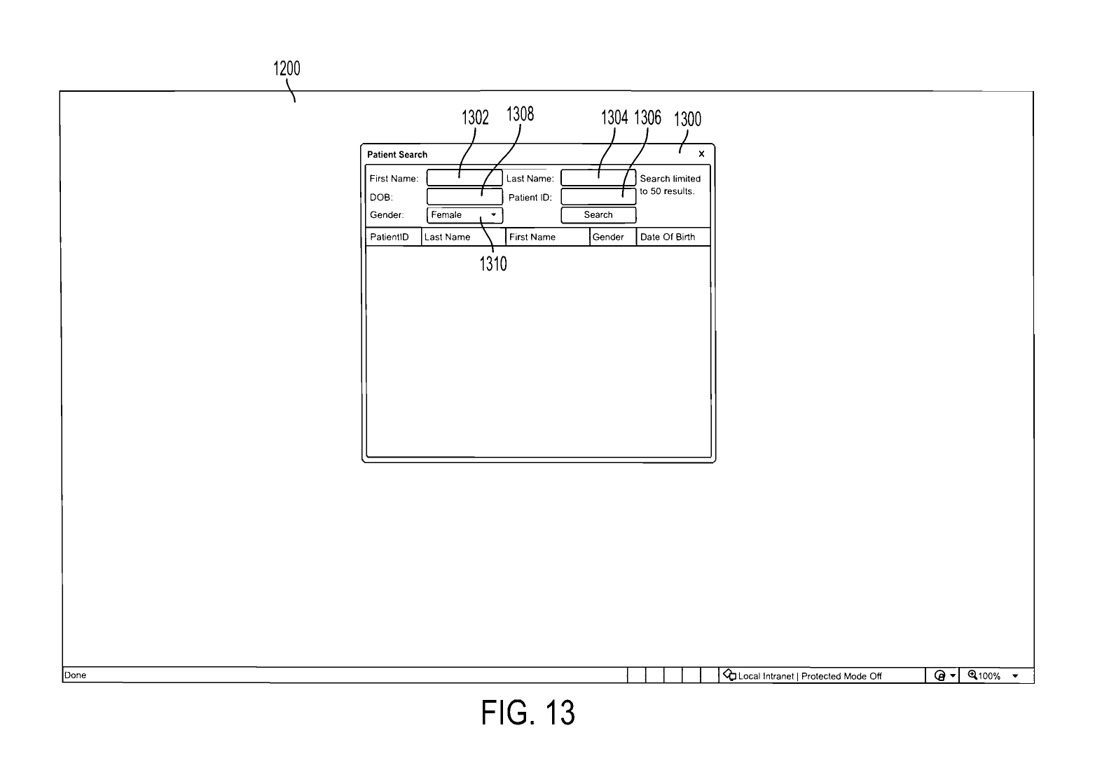

Once a site is selected, the “Patient Search” screen opens up in a new window, as shown in FIG. 13 as 1300. A user is able to search for patients within a site by the “first name” field 1302, “last name” field 1304, “patient ID” field 1306, or “date of birth” field 1308. A “single,” “multiple,” or “all criteria” may be used to locate a specific patient. The “gender” drop-down list 1310 is disabled.

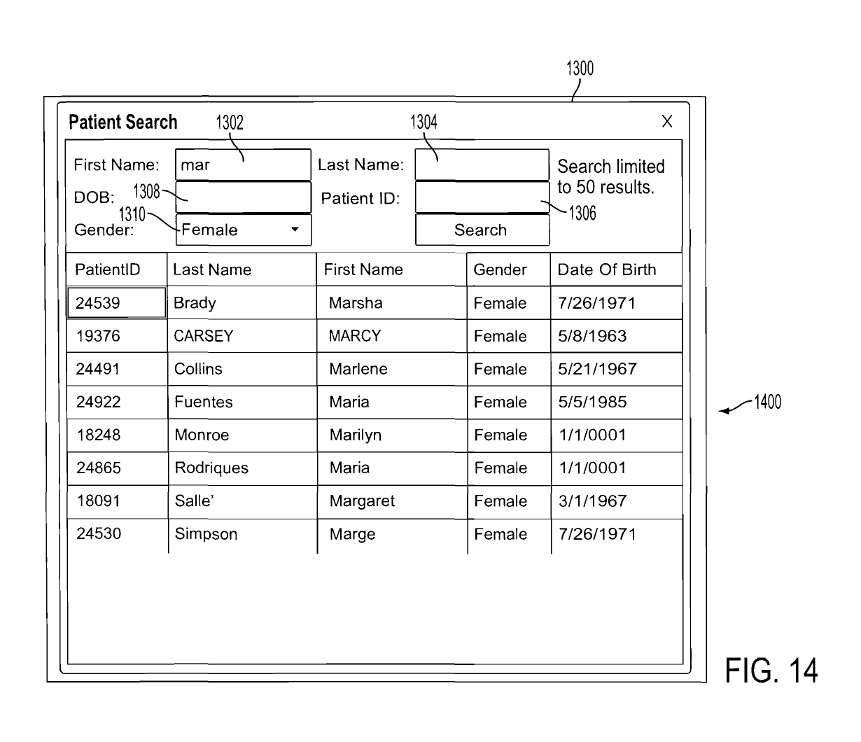

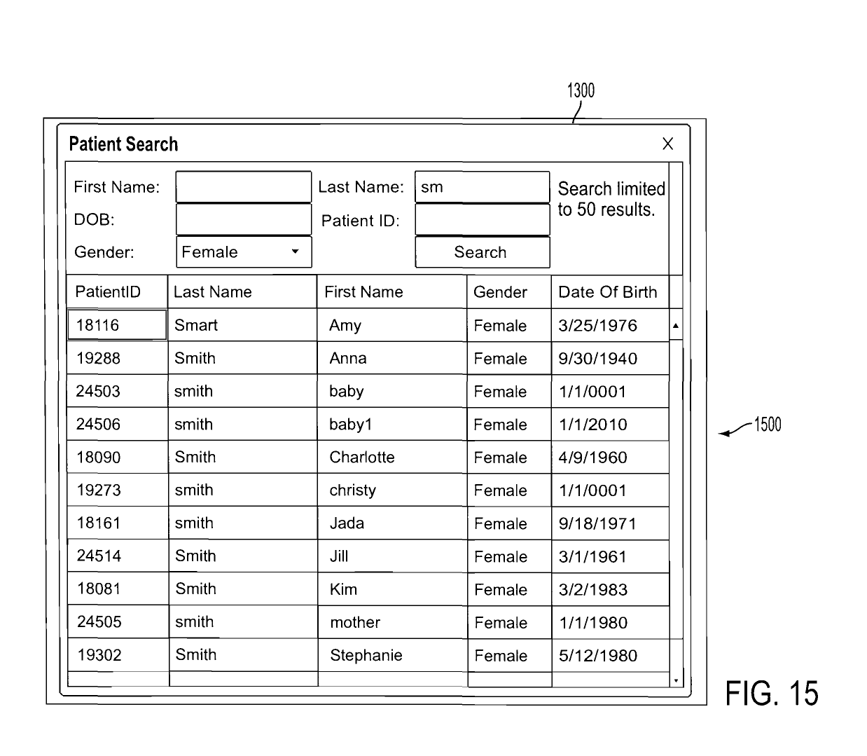

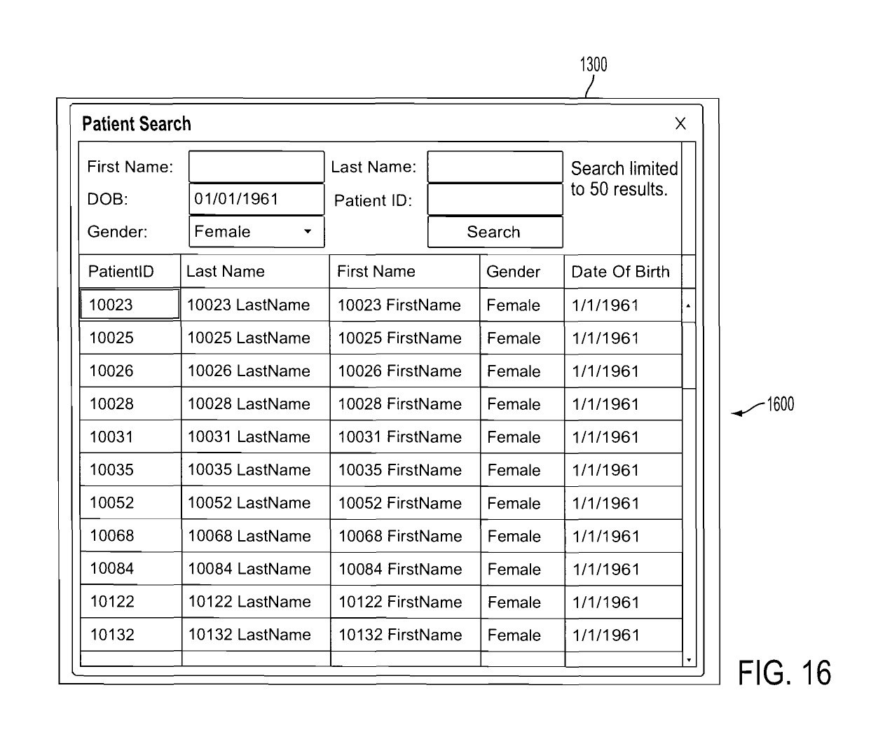

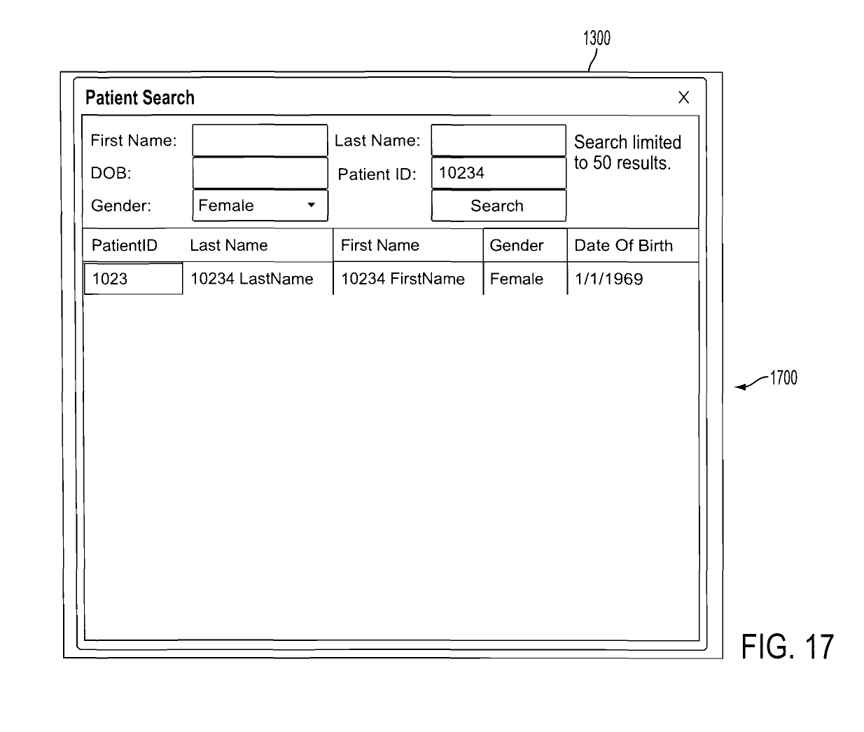

Search results are shown in FIG. 14 as a list 1400 for a first-name search, in FIG. 15 as a list 1500 for a last-name search, in FIG. 16 as a list 1600 for a date-of-birth search, and in FIG. 17 as a list 1700 for a patient-ID search. Table IX discloses the functionality of the patient search.

TABLE IX

| Label Name | Control Type | Description |
|---|---|---|
| First Name | Text Box | Action: User enters patient's first name and |
| | | clicks on “Search” button. |
| | | Expected result: A list of patients with entered |
| | | first name as their first name or a part of their |
| | | first name shows up on the screen. |
| Last Name | Text Box | Action: User enters patient's last name and |
| | | clicks on “Search” button. |
| | | Expected result: A list of patients with the |
| | | name entered as their last name or a part of |
| | | their last name shows up on the screen. |
| DOB | Text Box | Action: User types in a patient's date of birth |
| | | and clicks on “Search” button |
| | | (mm/dd/yyyy format). |
| | | Expected result: A list of patients with that |
| | | date of birth as their actual date of birth shows |
| | | up on the screen. |
| Patient ID | Text Box | Action: User types in a patient's ID number |
| | | and clicks on “Search” button. |
| | | Expected result: A patient shows up on the |
| | | screen as a match to the ID number that was |
| | | entered in the search. |
| Gender | Text Box | The “Gender” field is always set to Female; |
| | | the user is not able to change the value of that |
| | | field. |
| Search | Button | Action: User enters search criteria and clicks |
| | | on “Search” button. |
| | | Expected result: A list of patients that matches |
| | | entered criteria shows up on the screen. |
| | | If no criteria is entered in the search fields and |
| | | the user clicks on the “Search” button, a list of |
| | | the first 50 patients sorted by their ID numbers |
| | | will show up on the screen. |

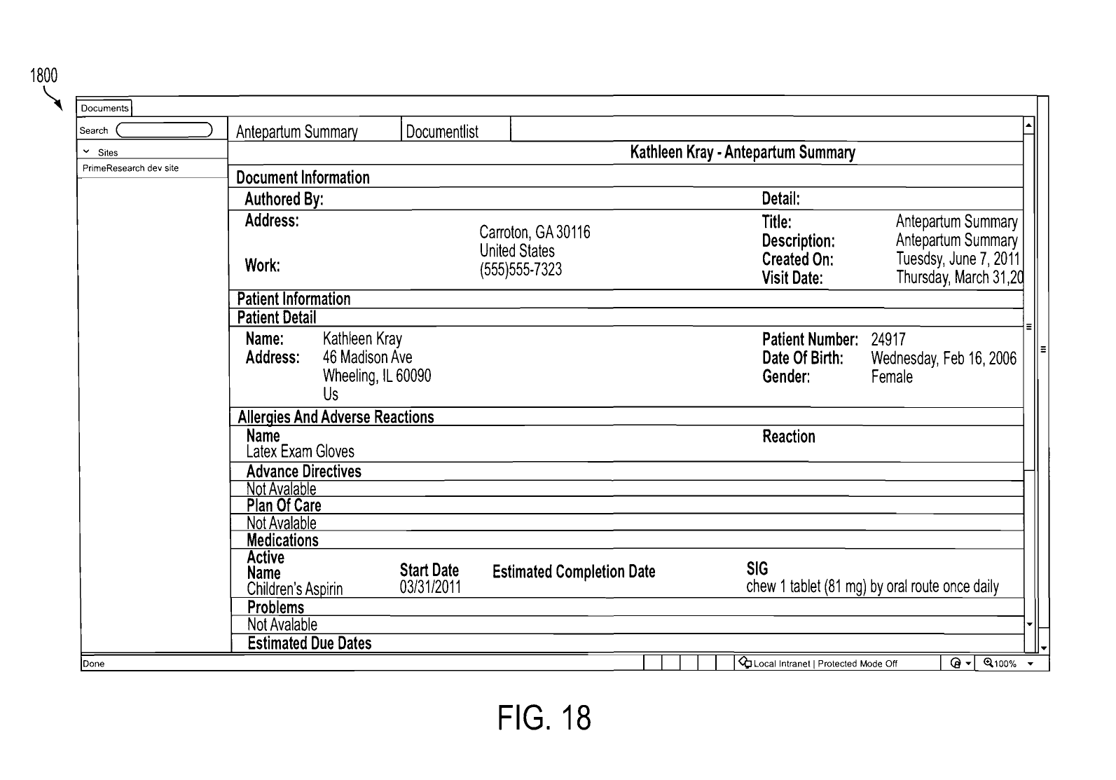

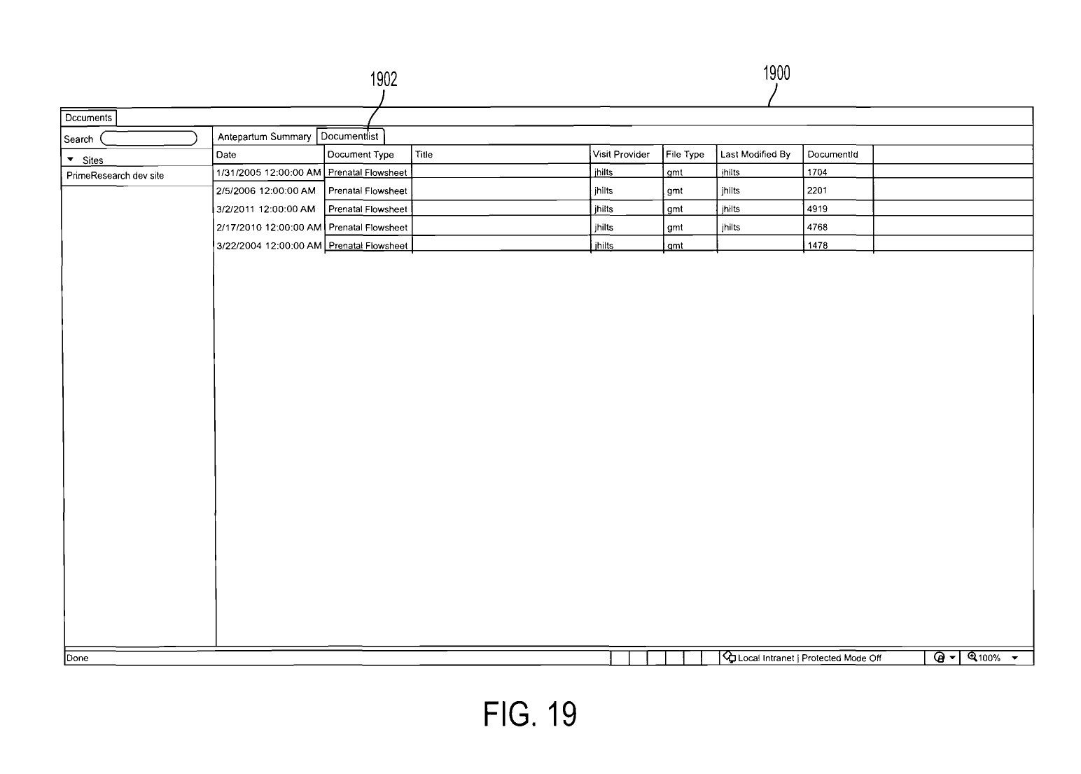

To access a patient's Antepartum Summary and Document List, the user must select a patient from a search result list by clicking on the row containing the person's information. A patient's Antepartum summary, shown in FIG. 18 as 1800, includes the person's demographic and medical information pulled from PrimeSUITE. Antepartum Summary title must contain the selected patient's name. Table X provides further disclosure.

TABLE X

| | Control | |
|---|---|---|
| Label Name | Type | Description |
| Antepartum | Tab | Action: User is able to view patient records that |
| Summary | | relate to the Antepartum Summary such as Patient |
| | | Detail, Allergies, Advance Directives, Plan of Care, |
| | | Medications, Problems, Estimated Due Dates, |
| | | Family History, etc. |
| | | Expected result: Patient information is viewable |
| | | on the screen. |

The document list, shown in FIG. 19 as 1900, will now be disclosed with reference to Tables XI and XII.

TABLE XI

| | Control | |
|---|---|---|
| Label Name | Type | Description |
| Document List | Tab | Action: User clicks on “Document Type” to pull |
| | | up Prenatal Flowsheet. Also, any documents that |
| | | were selected in the Community Document List |
| | | will now be available to view. |
| | | Expected result: A new window shows the |
| | | Prenatal Flowsheet, Lab Flowsheet data and any |
| | | other documents selected in the Community |
| | | Document List allows the user is to select the |
| | | desired print settings. |

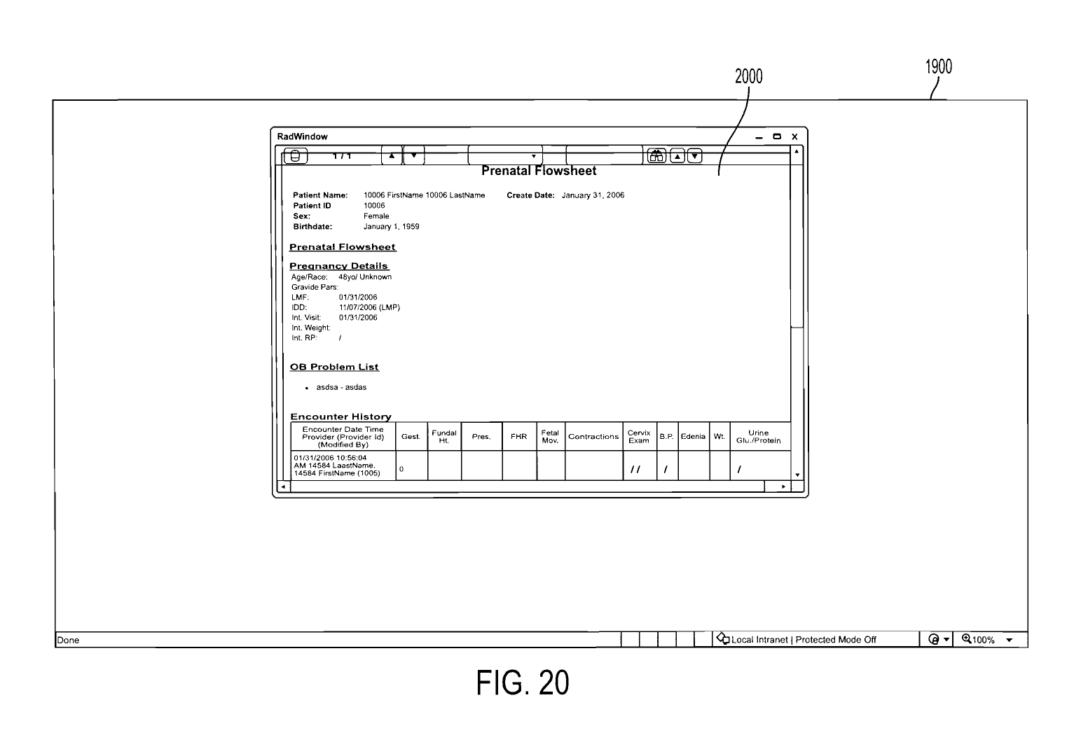

The “Document List” tab 1902 contains all open prenatal flow sheets for the selected patient. Lab flow sheets show up for those patients with open sheets in PrimeSUITE. To view and navigate through a particular document from the list, the user must click on the document, which is then displayed in a new window, as shown in FIG. 20 as 2000. The user is able to print a selected document should the process call for printing. The user is able to search for a key word within an open medical document in order to easily locate that word.

TABLE XII

| | Control | |
|---|---|---|
| Label Name | Type | Description |
| Print | Button | Action: User clicks on “Print” button. |
| | | Expected result: A new window with print |
| | | options opens up and a user is able to select |
| | | desired print settings. |
| Search | Text Box/ | Action: User types a key word into the search |
| | Button | box and hits search button. |
| | | Expected result: The search function navigates |
| | | to a place where the entered key word is present |
| | | and highlights it. |

While a preferred embodiment of the present invention has been set forth in detail, those skilled in the art who have reviewed the present disclosure will readily appreciate that other embodiments can be realized within the scope of the invention. For example, the arrangements of elements in the user interfaces are illustrative rather than limiting. Also, various labor and delivery staff can be given access to more or less information as needed. Therefore, the present invention should be construed as limited only by the appended claims.

What is claimed is:

1. A system for tracking and reporting clinical events over an extended computer network, the system comprising:
a plurality of Electronic Health Record (EHR) systems that are built on the same architecture and configured to capture patient data for a plurality of patients at a plurality of healthcare provider sites during a plurality of encounters with those patients, said plurality of EHR systems being configured to capture and transmit the patient data in a common data format that specifies information to be collected and a format for the information to be collected; and
an enhanced services server built on the same architecture as the plurality of EHR systems and that is in electronic data communication with the plurality of EHR systems via a network connection and configured to transmit and receive the patient data in the common data format, the enhanced services server including:
pregnancy information functionality for collecting information related to pregnancies of the plurality of patients; and
view functionality for allowing a health-care provider to view only the information related to the pregnancies of the plurality of patients.

2. The system of claim 1, wherein the information related to the pregnancies of the plurality of patients comprises prenatal flow sheets, prenatal laboratory results, and an antepartum summary.

3. The system of claim 2, wherein the information related to the pregnancies of the plurality of patients further comprises an antepartum record profile.

4. The system of claim 1, wherein the view functionality comprises functionality for receiving an input from an administrator indicating that the health-care provider is to have access only to the information related to the pregnancies of the plurality of patients and for limiting the health-care provider's access such that the health-care provider can access only the information related to the pregnancies.

5. The system of claim 4, wherein the view functionality further comprises functionality for receiving an input from the administrator indicating that the health-care provider is to have access to a subset of the information related to the pregnancies of the plurality of patients and for limiting the health-care provider's access such that the health-care provider can access only the subset of the information related to the pregnancies of the plurality of patients.

6. The system of claim 5, wherein the subset is selected from the group consisting of a document list and an antepartum summary.

7. The system of claim 1, wherein the view functionality comprises functionality for receiving a site search query from the health-care provider and for performing a search through the sites in accordance with the site search query.

8. The system of claim 8, wherein the view functionality comprises functionality for receiving a selection of one of the sites and a patient search query from the health-care provider and for performing a search through the patients at the selected site in accordance with the patient search query.

9. The system of claim 8, wherein the view functionality comprises functionality for providing a plurality of fields for the health-care provider to input the patient search query.

10. The system of claim 9, wherein the plurality of fields comprise at least one of a first name, a last name, a date of birth, and a patient identification number.

11. A method for tracking and reporting clinical events over an extended computer network, the method comprising:
(a) providing a plurality of Electronic Health Record (EHR) systems that are built on the same architecture and configured to capture patient data for a plurality of patients at a plurality of healthcare provider sites during a plurality of encounters with those patients, said plurality of EHR systems being configured to capture and transmit the patient data in a common data format that specifies information to be collected and a format for the information to be collected; and
(b) providing an enhanced services server built on the same architecture as the plurality of EHR systems and that is in electronic data communication with the plurality of EHR systems via a network connection and configured to transmit and receive the patient data in the common data format;
(c) collecting information related to pregnancies of the plurality of patients in the enhanced services server; and
(d) allowing a health-care provider to view only the information related to the pregnancies of the plurality of patients.

12. The method of claim 11, wherein the information related to the pregnancies of the plurality of patients comprises prenatal flow sheets, prenatal laboratory results, and an antepartum summary.

13. The method of claim 12, wherein the information related to the pregnancies of the plurality of patients further comprises an antepartum record profile.

14. The method of claim 11, wherein step (d) comprises receiving an input from an administrator indicating that the health-care provider is to have access only to the information related to the pregnancies of the plurality of patients and for limiting the health-care provider's access such that the health-care provider can access only the information related to the pregnancies.

15. The method of claim 14, wherein step (d) further comprises receiving an input from the administrator indicating that the health-care provider is to have access to a subset of the information related to the pregnancies of the plurality of patients and for limiting the health-care provider's access such that the health-care provider can access only the subset of the information related to the pregnancies of the plurality of patients.

16. The method of claim 15, wherein the subset is selected from the group consisting of a document list and an antepartum summary.

17. The method of claim 1, wherein step (d) comprises receiving a site search query from the health-care provider and for performing a search through the sites in accordance with the site search query.

18. The method of claim 18, wherein step (d) comprises receiving a selection of one of the sites and a patient search query from the health-care provider and for performing a search through the patients at the selected site in accordance with the patient search query.

19. The method of claim 18, wherein step (d) comprises providing a plurality of fields for the health-care provider to input the patient search query.

20. The method of claim 19, wherein the plurality of fields comprise at least one of a first name, a last name, a date of birth, and a patient identification number.
